(19) United States
(12) Patent Application Publication
(10) Pub. No.: US 2026/0033918 A1
(43) Pub. Date: Feb. 5, 2026

(54) SUPPORT STRUCTURES FOR 3D PRINTED ORTHODONTIC DENTAL APPLIANCES AND MANUFACTURING METHODS THEREOF

(71) Applicant: LUXCREO INC., Chicago, IL (US)

(72) Inventors: Pengyuan DAI, Ningbo (CN); Sudhanva Raj GOVINDARAJAN, Chicago, IL (US); Yang LI, Beijing (CN); Boxiang TANG, Beijing (CN); Lingdong CHEN, Ningbo (CN); Guang ZHU, Ningbo (CN)

(73) Assignee: LUXCREO INC., Chicago, IL (US)

(21) Appl. No.: 19/357,074

(22) Filed: Oct. 13, 2025

Related U.S. Application Data
(63) Continuation of application No. PCT/US2024/024546, filed on Apr. 14, 2024.
(60) Provisional application No. 63/496,386, filed on Apr. 14, 2023.
(60) Provisional application No. 63/503,493, filed on May 21, 2023.
(60) Provisional application No. 63/593,957, filed on Oct. 27, 2023.

(51) Int. Cl. A61C 7/08; B33Y 80/00

(52) U.S. Cl. CPC A61C 7/08; B33Y 80/00

(57) ABSTRACT

The present disclosure provides a support of a 3D printed orthodontic dental appliance is provided. The orthodontic dental appliance includes a shell structure defined by an inner contour surface and an outer contour surface. The support comprises: a middle support including a middle support base mesh and a plurality of middle support struts and a main support configured to connect the middle support to a build platform of a 3D printing device used to print the orthodontic dental appliance. One end of each middle support strut of the plurality of middle support struts is connected to the orthodontic dental appliance at a junction of the inner contour surface and the outer contour surface, and the other end of the middle support strut is connected to a rim of the middle support base mesh.

### CROSS-REFERENCE TO RELATED APPLICATIONS

This application is a continuation of International Patent Application No. PCT/US2024/024546, filed on Apr. 14, 2024, which claims priority to U.S. Provisional Patent Application No. 63/496,386, filed on Apr. 14, 2023, U.S. Provisional Patent Application No. 63/503,493, filed on May 21, 2023, and U.S. Provisional Patent Application No. 63/593,957, filed on Oct. 27, 2023, the entire contents of each of which are hereby incorporated by reference.

### TECHNICAL FIELD

The present disclosure relates to the field of 3D printing technology, and in particular to support structures and manufacturing methods of 3D printed orthodontic dental appliances.

### BACKGROUND

A technical principle of 3D printing is to layer a three-dimensional model first, then obtain contour information or image information of each layer, and use powdered metal or photocurable resin or other adhesive materials to complete printing of the printed objects layer by layer.

Since 3D printing is to solidify the materials layer by layer and superimpose the materials layer by layer, in principle, an upper structure of a model is generally required to be supported by a lower part of the model. Therefore, if some parts of the printed object are suspended, it is necessary to design support to support these suspended parts of the printed object. For some geometric structures, support is necessary to ensure the stability and quality of the printing process.

When directly printing orthodontic dental appliances with a thin shell structure, such as an orthodontic dental appliance, printing support is necessary since the shell structure is thin that may undergo deforming during printing. The support is also necessary during the washing and cleaning post-process to maintain the form of the orthodontic dental appliance. Generally, the more stable supports used during printing and washing, the better-quality (e.g., more accurate, less deform) orthodontic dental appliances will be obtained. However, using too much support causes other problems, such as resin wastes, difficulty to remove complex support structures, and washing and cleaning agent wastes. All these issues may increase the manufacturing cost and complexity. Therefore, novel support structures are needed to overcome these challenges.

### SUMMARY

According to a first aspect of the present disclosure, a support of a 3D printed orthodontic dental appliance is provided. The orthodontic dental appliance includes a shell structure defined by an inner contour surface and an outer contour surface. The support comprises: a middle support including a middle support base mesh and a plurality of middle support struts and a main support configured to connect the middle support to a build platform of a 3D printing device used to print the orthodontic dental appliance. One end of each middle support strut of the plurality of middle support struts is connected to the orthodontic dental appliance at a junction of the inner contour surface and the outer contour surface, and the other end of the middle support strut is connected to a rim of the middle support base mesh.

In some embodiments, an angle between a plane tangential to teeth of the shell structure and the build platform is in a range of 20° to 90°.

In some embodiments, the angle between the plane tangential to the teeth of the shell structure and the build platform is in a range of 50° to 75°.

In some embodiments, the middle support base mesh includes a plurality of inter-connected triangles.

In some embodiments, the main support includes two side support walls and a connecting support wall connecting the two side support walls, wherein respective ends of the two side support walls are connected to the rim of the middle support base mesh at least at two ends of the orthodontic dental appliance.

In some embodiments, the connecting support wall connects to the two side support walls directly at side surfaces of the two side support walls.

In some embodiments, the support further comprises a connection part disposed between the main support and the build platform and be configured to increase an attachment of the main support to the build platform.

In some embodiments, the main support further includes: a central support that at least connects a middle part of the middle support to the build platform.

In some embodiments, the central support has a triangle shape of three end points at the middle part of the middle support, a projected location of the middle part of the middle support on the build platform along a projection direction parallel to a printing direction of the 3D printing device, and a middle part of the connecting support wall, respectively.

In some embodiments, the main support further includes at least one side beam that connects the central support to one of the two side support walls.

In some embodiments, the central support is a column with one end at the middle part of the middle support and the other end at a projected location of the middle part of the middle support on the build platform along a projection direction parallel to a printing direction of the 3D printing device.

In some embodiments, the main support further includes two additional connecting walls that connect the projected location of the middle part of the middle support on the build platform and the connecting support wall to form a triangular main support base structure.

In some embodiments, the main support includes a main support base mesh and a plurality of main support struts, wherein one end of the plurality of main support struts is connected to the rim of the middle support base mesh and the other end of the plurality of main support struts is connected to a rim of the main support base mesh.

In some embodiments, the main support base mesh includes a plurality of inter-connected triangles.

In some embodiments, a diameter of each triangle side of inter-connected triangles of the middle support base mesh is smaller than a diameter of each triangle side of the inter-connected triangles of the main support base mesh.

In some embodiments, a cross-sectional area of each middle support strut along a direction perpendicular to a printing direction of the 3D printing device is smaller than a cross-sectional area of each main support strut along the direction perpendicular to the printing direction of the 3D printing device.

In some embodiments, an area of a middle support contacting point of each middle support strut to the orthodontic dental appliance is larger than an area of a main support contacting point of each main support strut to the middle support base mesh.

In some embodiments, an area of a middle support contacting point of each middle support strut to the orthodontic dental appliance is less than a cross-sectional area of the corresponding middle support strut along a direction perpendicular to a printing direction of the 3D printing device, or an area of a main support contacting point of each main support strut to the middle support base mesh is less than a cross-sectional area of the corresponding main support strut along the direction perpendicular to the printing direction of the 3D printing device.

In some embodiments, at least two adjacent main support struts are combined into one but keeping corresponding main support contacting points connected to the rim of the middle support base mesh.

In some embodiments, a total number of the plurality of middle support struts is smaller than a total number of the main support struts.

According to a second aspect of the present disclosure, a 3D printing method of a 3D printed orthodontic dental appliance is provided. The method may include: constructing a support of the orthodontic dental appliance, wherein the orthodontic dental appliance includes a shell structure defined by an inner contour surface and an outer contour surface, the support includes: a middle support including a middle support base mesh and a plurality of middle support struts, wherein one end of each middle support strut of the plurality of middle support struts is connected to the orthodontic dental appliance at a junction of the inner contour surface and the outer contour surface and the other end of the middle support strut is connected to the rim of the middle support base mesh, and a main support configured to connect the middle support to a build platform of a 3D printing device used to print the orthodontic dental appliance; printing the orthodontic dental appliance and the support using the 3D printing device; removing the main support; washing the orthodontic dental appliance with the middle support; and removing the middle support.

According to a third aspect of the present disclosure, a support of a 3D printed orthodontic dental appliance is provided. The orthodontic dental appliance includes a shell structure defined by an inner contour surface and an outer contour surface. The support comprises: a support base on a build platform of a 3D printing device used to print the orthodontic dental appliance, the build platform is perpendicular to a printing direction of the 3D printing device; and a support wall with one end connected to the support base and the other end connected to a portion of the outer contour surface corresponding to a biting edge of at least one anterior tooth of a user of the orthodontic dental appliance.

In some embodiments, the support wall is perpendicular to the support base.

In some embodiments, a height of the support wall is in a range of 2 mm-8 mm, a thickness of the support wall is in a range of 0.3 mm-0.8 mm, or a thickness of the support base is in a range of 1.0 mm-2.0 mm.

In some embodiments, a length of a connecting part of the support wall and the shell structure is in a range of 1.2 cm-3 cm.

In some embodiments, a connecting part of the support wall and the shell structure has a plurality of separated support connection points.

In some embodiments, a distance between two adjacent support connection points is in a range of 0.5 mm-1.5 mm.

In some embodiments, the support further comprises at least one support column with one end connected to the outer contour surface of the shell structure and the other end connected to the support base.

In some embodiments, the at least one support column connects the support base and a middle point of the biting edge of the at least one anterior tooth of the user.

In some embodiments, the at least one support column has a main body that is perpendicular to the support base.

In some embodiments, the at least one support column further has a columnar contacting head that is at an angle to the main body.

In some embodiments, a diameter of the columnar contacting head is smaller than a diameter of the main body.

In some embodiments, the diameter of the columnar contacting head is in a range of 0.5 mm-1.0 mm, or the diameter of the main body is in a range of 1.0 mm-3.0 mm.

In some embodiments, an angle between a plane tangential to teeth of the shell structure and the build platform is in a range of 25° to 90°.

In some embodiments, the angle between the plane tangential to the teeth of the shell structure and the build platform is in a range of 50° to 55°.

In some embodiments, the support is removed from the orthodontic dental appliance with an one-click motion.

According to a fourth aspect of the present disclosure, a 3D printing method of a 3D printed orthodontic dental appliance is provided. The method may include: constructing a support of the orthodontic dental appliance, wherein the orthodontic dental appliance includes a shell structure defined by an inner contour surface and an outer contour surface, the support includes: a support base on a build platform of a 3D printing device used to print the orthodontic dental appliance, the build platform is perpendicular to a printing direction of the 3D printing device, and a support wall with one end connected to the support base and the other end connected to a portion of the outer contour surface corresponding to a biting edge of at least one anterior tooth of a user of the orthodontic dental appliance; printing the orthodontic dental appliance and the support using the 3D printing device; washing the orthodontic dental appliance with the support; and removing the support with an one-click motion.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities, and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. The drawings are not scaled. These embodiments are non-limiting exemplary embodiments, in which like reference numerals represent similar structures throughout the several views of the drawings, and wherein:

FIG. 1 is a schematic diagram illustrating a 3D printed orthodontic dental appliance with an exemplary support according to some embodiments of the present disclosure;

FIG. 2 is a schematic diagram illustrating a 3D printed orthodontic dental appliance with an exemplary support according to some embodiments of the present disclosure;

FIG. 3 is a top view of the support in FIG. 2;

FIG. 4 is a schematic diagram illustrating a 3D printed orthodontic dental appliance with an exemplary support according to some embodiments of the present disclosure;

FIG. 5 is a schematic diagram illustrating a 3D printed orthodontic dental appliance with an exemplary support according to some embodiments of the present disclosure;

FIG. 6A is a schematic diagram illustrating a 3D printed orthodontic dental appliance with an exemplary support according to some embodiments of the present disclosure;

FIG. 6B is another view of the 3D printed orthodontic dental appliance with the exemplary support in FIG. 6A;

FIG. 7 is a flowchart illustrating an exemplary process for printing a 3D printed orthodontic dental appliance according to some embodiments of the present disclosure;

FIG. 8 is a schematic diagram illustrating a 3D printed orthodontic dental appliance with an exemplary support according to some embodiments of the present disclosure;

FIG. 9 is a schematic diagram illustrating a 3D printed orthodontic dental appliance with an exemplary support according to some embodiments of the present disclosure;

FIG. 10 is a schematic diagram illustrating a support of a 3D printed orthodontic dental appliance according to some embodiments of the present disclosure; and

FIG. 11 is a flowchat illustrating an exemplary process for printing a 3D printed orthodontic dental appliance according to some embodiments of the present disclosure.

Reference numerals and represented structures: 3D printed orthodontic dental appliance: 10; shell structure: 11; inner contour surface: 12; outer contour surface: 13; junction: 14; support: 20; middle support: 30; middle support strut: 31; middle support contacting point 32; middle support base mesh: 33; rim of middle support base mesh: 34; main support: 40; main support strut: 41; main support contacting point: 42; main support base mesh: 43; rim of main support base mesh: 44; main support: 50; connecting support wall: 51; side support wall: 52; connection part: 53; central support: 54; side beam: 55; connecting wall: 56; build platform: 60; support: 210; support wall: 220; support connection point: 221; support base: 230; support column: 240; main body: 241; contacting head: 242; middle part of the middle support 30: A; the projected location of the middle part A: B; middle part of the connecting support wall: 51C.

### DETAILED DESCRIPTION

The following description is presented to enable any person skilled in the art to make and use the present disclosure and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including” when used in this disclosure, specify the presence of stated features, integers, steps, operations, elements, and/or components, but do not preclude the presence or addition of one or more other features, integers, steps, operations, elements, components, and/or groups thereof.

It will be understood that when a unit, element, structure, device is referred to as being “on,” “connected to,” or “coupled to,” another unit, element, structure, device, it may be directly on, connected or coupled to, or communicate with the other unit, element, structure, device, or an intervening unit, element, structure, device may be present, unless the context clearly indicates otherwise. As used herein, the term “and/or” includes any and all combinations of one or more of the associated listed items.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments in the present disclosure. It is to be expressly understood, the operations of the flowchart may be implemented not in order. Conversely, the operations may be implemented in an inverted order, or simultaneously. Moreover, one or more other operations may be added to the flowcharts. One or more operations may be removed from the flowcharts.

The embodiments present disclosure relate to a 3D printing support of a 3D printed orthodontic dental appliance, such as an aligner, a retainer, a nightguard, etc. When printing the orthodontic dental appliance, a 3D printing device may first print at least a part of the support on a build platform layer by layer, and then the 3D printing device may print the support and/or the orthodontic dental appliance. In some embodiments, the 3D printing device for printing the orthodontic dental appliance and the support may be a light curing 3D printer, a fused deposition 3D printer, or a powder bonding 3D printer. The build platform may be on a plane perpendicular to a printing direction of the 3D printing device.

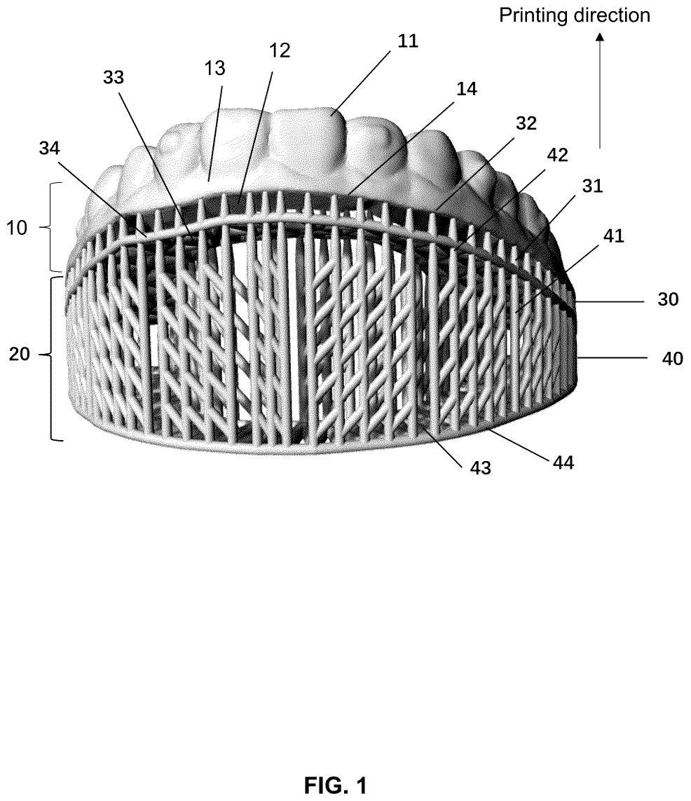

FIG. 1 is a schematic diagram illustrating a 3D printed orthodontic dental appliance with an exemplary support according to some embodiments of the present disclosure.

As shown in FIG. 1, a 3D printed orthodontic dental appliance 10 includes a shell structure 11 defined by an inner contour surface 12 and an outer contour surface 13. As used herein, the inner contour surface 12 refers to a surface of the orthodontic dental appliance 10 facing a users' teeth when the user wears the orthodontic dental appliance 10, and the outer contour surface 13 refers to a surface of the orthodontic dental appliance 10 that is away from the users' teeth when the user wears the orthodontic dental appliance 10. The inner contour surface 12 and the outer contour surface 13 may connect at a junction 14, which forms an opening of the shell structure 11.

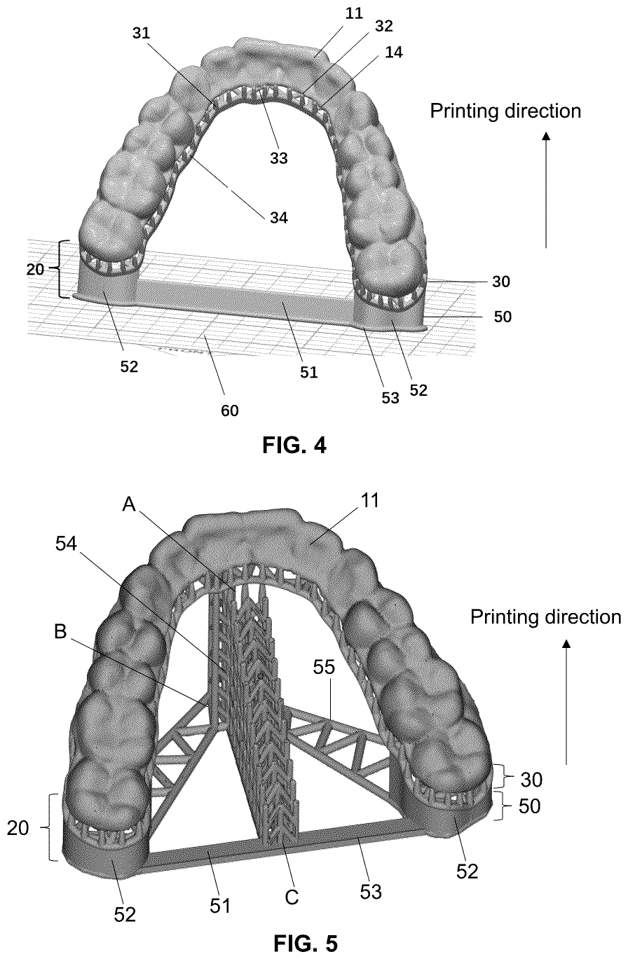

A support 20 of the orthodontic dental appliance 10 may include a middle support 30 and a main support 40. The middle support 30 may incldue a middle support base mesh 33 and a plurality of middle support struts 31. The middle support base mesh 33 has a rim 34 that has the same outline as the opening of the shell structure 11. One end of each middle support strut 31 may be connected to the orthodontic dental appliance 10 at the junction 14 of the inner contour surface 12 and the outer contour surface 13, and the other end of the middle support strut 31 may be connected to the rim 34 of the middle support base mesh 33. The main support 40 may be configured to connect the middle support 30 to a build platform (e.g., the build platform 60 shown in FIG. 4) of a 3D printing device used to print the orthodontic dental appliance 10. By designing a connection position between the orthodontic dental appliance 10 and the support 20 at the junction 14, a contacting area between the orthodontic dental appliance 10 and the middle support 30 is relatively small, after removal of the middle support 30, the orthodontic dental appliance 10 may require less time to polish compared to a support that is connected to the orthodontic dental appliance at the outer contour surface 12. Furthermore, if the connection position between the orthodontic dental appliance 10 and the support 20 is located at the outer contour surface 12, the polishing degree of the connection position may affect the smoothness and transparency of the orthodontic dental appliance 10, making polishing relatively difficult. Thus, by designing the connection position between the orthodontic dental appliance 10 and the support 20 at the junction 14, the polishing process can be further simplified and the polishing time can be further reduced. Moreover, if the orthodontic dental appliance 10 has a thin shell structure 10 (e.g., with a thickness less than 1.5 mm), by designing the connection position between the orthodontic dental appliance 10 and the support 20 at the junction 14, after removal of the main support 40, the support 20 (e.g., the middle support 30) may still support the orthodontic dental appliance 10 effectively, thereby reducing the deformation of the orthodontic dental appliance 10 during the subsequent washing. Therefore, when an orthodontic dental appliance with a relatively small thickness (e.g., less than 1.5 mm, such as 1.2 mm, 1 mm, 0.8 mm, etc.) and/or a relatively soft shell structure needs to be printed, an operator can adopt a support with the above-mentioned structure and arrangement to print the orthodontic dental appliance. For example, if an aligner whose thickness is generally less than 1.5 mm needs to be printed, the operator may adopt the support 20 to print the aligner.

In some embodiments, the middle support base mesh 33 may be a solid structure, so that the middle support base mesh 33 has high strength. In some embodiments, in order to decrease the weight of the middle support 30 to facilitate the subsequent processing (e.g., washing), the middle support base mesh 33 may include a plurality of inter-connected geometric shapes that support the shape of the shell structure 11. As a result, the orthodontic dental appliance 10 can be printed without deformation during printing. Furthermore, the role of the middle support base mesh 33 and/or the middle support struts 31 extends beyond printing to post-processing stages like cleaning, washing, and post-curing. Without the middle support base mesh 33 and/or the middle support struts 31, the thin shell structure is highly susceptible to experiencing shrinkage or other forms of shape alteration during these post-processing steps. In some embodiments, the inter-connected geometric shapes may include triangles, quadrilaterals, pentagons, hexagons, other irregular shapes, or the like, or any combination thereof. For example, since a triangle is a geometric shape with the most stable structure but the least number of sides, the middle support base mesh 33 may include a plurality of inter-connected triangles (as shown in FIG. 3) to reinforce the support 20, thereby avoiding the deformation of the orthodontic dental appliance 10 during printing.

In some embodiments, at least two adjacent middle support struts 31 may be combined into one but keeping corresponding middle support contacting points 32 connected to the orthodontic dental appliance 10. In this way, less printing material (e.g., resin) may be used to build the middle support 30 but still achieving the stabilization effect from the middle support 30. For example, three middle support struts 31 may be combined into one but keeping the three contacting points 32 with the orthodontic dental appliance 10.

In some embodiments, as shown in FIG. 1, the main support 40 may include a main support base mesh 43 and a plurality of main support struts 41. The main support base mesh 43 has a rim 44 that defines a surface that connects the orthodontic dental appliance 10 to the build platform of the 3D printing device. One end of the plurality of main support struts 41 is connected to the rim 34 of the middle support base mesh 33 and the other end of the plurality of main support struts 41 is connected to the rim 44 of the main support base mesh 43.

Similar to the middle support base mesh 33, the main support base mesh 43 may also include a plurality of inter-connected geometric shapes to reinforce the support 20. In some embodiments, the inter-connected geometric shapes may include triangles, quadrilaterals, pentagons, hexagons, other irregular shapes, or the like, or any combination thereof. In some embodiments, in order to reinforce the support 20 as much as possible, the main support base mesh 43 may include a plurality of inter-connected triangles.

In some embodiments, in order to support the orthodontic dental appliance 10 more stable and save printing material, a diameter of a side of the inter-connected geometric shapes of the middle support base mesh 33 may be smaller than a diameter of a side of the inter-connected geometric shapes of the main support base mesh 43. This is because when the orthodontic dental appliance 10 is first printed, the main support base mesh 43 is the first part of the entire support 20 to be printed, which is a large horizontal surface and is difficult to be printed and lifted from the bottom of a resin tank of the 3D printing device, thus the main support base mesh 43 should have thicker sides to provide better attachment to the build platform and be easily lifted.

In some embodiments, when both the middle support base mesh 33 and the main support base mesh 43 have a plurality of inter-connected triangles, a diameter of each triangle side of the inter-connected triangles of the middle support base mesh 33 is smaller than a diameter of each triangle side of the inter-connected triangles of the main support base mesh 43. In some embodiments, the diameter of each triangle side of the middle support base mesh 33 may be in a range of 0.4 mm-2 mm, and the diameter of each triangle side of the main support base mesh 43 may be in a range of 0.5 mm-3 mm. In some embodiments, the diameter of each triangle side of the middle support base mesh 33 may be in a range of 0.6 mm-1.6 mm, and the diameter of each triangle side of the main support base mesh 43 may be in a range of 1 mm-2.2 mm. In some embodiments, the diameter of each triangle side of the middle support base mesh 33 may be in a range of 0.8 mm-1.6 mm, and the diameter of each triangle side of the main support base mesh 43 may be in a range of 1.2 mm-2.2 mm.

In some embodiments, in order to ensure the shape of the orthodontic dental appliance 10 and save washing agent, a cross-sectional area of each middle support strut 31 along a direction perpendicular to the printing direction of the 3D printing device is smaller than a cross-sectional area of each main support strut 41 along the direction perpendicular to the printing direction of the 3D printing device. This is because the main support 40 may be removed for one or more post-processings (e.g., washing) while the middle support 30 can be post-processed (e.g., washed) together with the shell structure 11 to support the shell structure 11 throughout the post-processes, therefore thinner middle struts use less washing agent and make the post-processing more economical. In some embodiments, a diameter of the middle support strut 31 may be in a range of 0.4 mm-2 mm, and a diameter of the main support strut 41 may be in a range of 0.5 mm-3 mm. In some embodiments, a diameter of the middle support strut 31 may be in a range of 0.6 mm-1.6 mm, and a diameter of the main support strut 41 may be in a range of 1 mm-2.2 mm. In some embodiments, the diameter of the middle support strut 31 may be in a range of 0.8 mm-1.6 mm, and the diameter of the main support strut 41 may be in a range of 1.2 mm-2.2 mm. In some embodiments, the diameter of the middle support strut 31 may be in a range of 1 mm-1.5 mm, and the diameter of the main support strut 41 may be in a range of 1.2 mm-2 mm. In some embodiments, the diameter of the middle support strut 31 may be in a range of 1 mm-1.2 mm, and the diameter of the main support strut 41 may be in a range of 1.2 mm-1.5 mm.

In some embodiments, a diameter of a middle support contacting point 32 of a middle support strut 31 to the orthodontic dental appliance 10 may be the same as a diameter of a main support contacting point 42 of a main support strut 41 to the middle support base mesh 33, or an area of the middle support contacting point 32 of the middle support strut 31 to the orthodontic dental appliance 10 may be the same as an area of the main support contacting point 42 of the main support strut 41 to the middle support base mesh 33. It should be noted that in the present disclosure, a contacting point (including the middle support contacting point 32 and the main main support contacting point 42) between two structures may be a contacting surface with a certain area.

In some embodiments, in order to facilitate the separation of the main support 40 from the middle support 30 without causing the middle support 30 to separate from the orthodontic dental appliance 10 (i.e., the shell structure 11), the diameter of the middle support contacting point 32 may be lager than the diameter of the main support contacting point 42, or area of the middle support contacting point 32 may be larger than the area of the main support contacting point 42. In this way, when the main support 40 is separated from the middle support 30 before post-processing (e.g., washing), the middle support 30 can still remain attached to the shell structure 11. In some embodiments, the diameter of the middle support contacting point 32 may be in a range of 0.4 mm-2.0 mm, and the diameter of the main support contacting point 42 may be in a range of 0.3 mm-1.5 mm. In some embodiments, the diameter of the middle support contacting point 32 may be in a range of 0.4 mm-1.5 mm, and the diameter of the main support contacting point 42 may be in a range of 0.3 mm-1.3 mm. In some embodiments, the diameter of the middle support contacting point 32 may be in a range of 0.4 mm-1.0 mm, and the diameter of the main support contacting point 42 may be in a range of 0.4 mm-1.0 mm. In some embodiments, the diameter of the middle support contacting point 32 may be in a range of 0.5 mm-1.0 mm, and the diameter of the main support contacting point 42 may be in a range of 0.4 mm-0.8 mm.

In some embodiments, in order to facilitate the separation of the middle support 30 from the orthodontic dental appliance 10 (i.e., the shell structure 11), an area of each middle support contacting point 32 of a middle support strut 31 to the orthodontic dental appliance 10 may be less than a cross-sectional area of the corresponding middle support strut 31 along the direction perpendicular to the printing direction of the 3D printing device. Similarly, in some embodiments, in order to facilitate the separation of the main support 40 from the middle support 30, an area of a main support contacting point 42 of each main support strut 41 to the middle support base mesh 33 may be less than a cross-sectional area of the corresponding main support strut 41 along the direction perpendicular to the printing direction of the 3D printing device.

In some embodiments, in order to ensure the support capability of the middle support 30 and save printing material, a space between two adjacent middle support contacting points 32 may be smaller than or equal to a space between two adjacent main support contacting points 42. In some embodiments, in order to maintain the support effect of the middle support 30 and save materials during the post-processing, the space between two adjacent middle support contacting points 32 may be in a range of 1 mm-5 mm. In some embodiments, the space between two adjacent middle support contacting points 32 may be in a range of 1.5 mm-4.5 mm. In some embodiments, the space between two adjacent middle support contacting points 32 may be in a range of 2 mm-4 mm. In some embodiments, the space between two adjacent middle support contacting points 32 may be in a range of 2.5 mm-3.5 mm. In some embodiments, the space between two adjacent middle support contacting points 32 may be 3 mm. In some embodiments, the space between two adjacent main support contacting points 42 may be in a range of 1 mm-5 mm. In some embodiments, the space between two adjacent main support contacting points 42 may be in a range of 1.5 mm-4.5 mm. In some embodiments, the space between two adjacent main support contacting points 42 may be in a range of 2 mm-4 mm. In some embodiments, the space between two adjacent main support contacting points 42 may be in a range of 2.5 mm-3.5 mm.

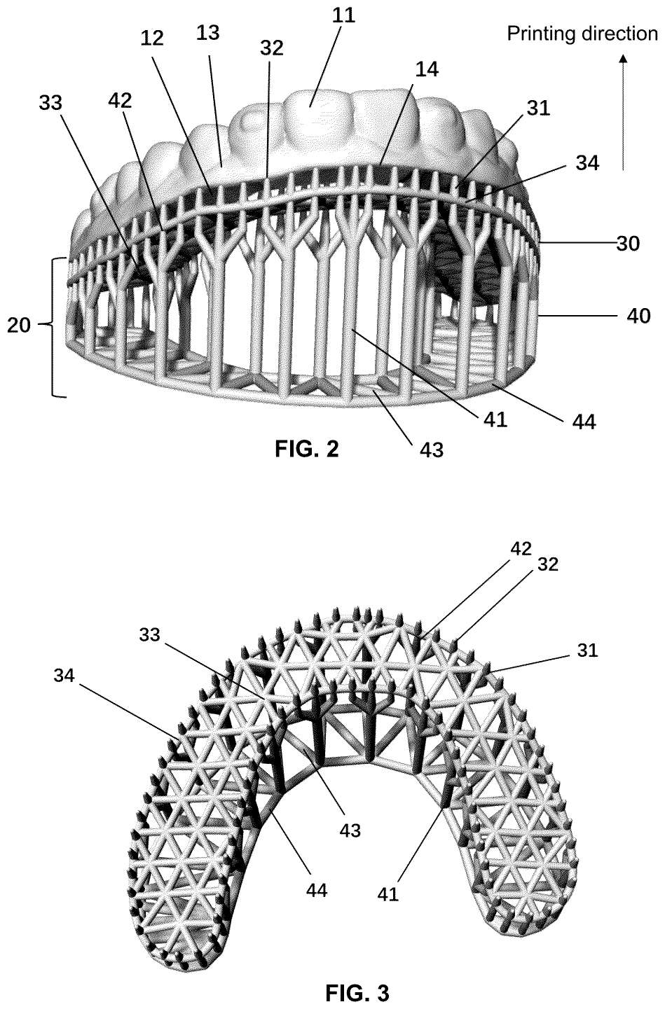

FIG. 2 is a schematic diagram illustrating a 3D printed orthodontic dental appliance with an exemplary support according to some embodiments of the present disclosure. FIG. 3 is a top view of the support in FIG. 2.

In some embodiments, at least two adjacent main support struts 41 in FIG. 1 may be combined into one but keeping corresponding contacting points connected to the rim 34 of the middle support base mesh 33. In this way, less printing material (e.g., resin) may be used to build the main support 40 but still achieving the stabilization effect from the main support 40. For example, as shown in FIG. 2, three main support struts 41 may be combined into one but keeping the three contacting points 42 with the middle support base mesh 33.

In some embodiments, since an angle between a plane tangential to teeth of the shell structure 11 and the build platform may be related to the spatial layout of the orthodontic dental appliance 10 and the support 20, which can affect e.g., a printing time, the throughput, etc., of the orthodontic dental appliance 10 and the support 20, the angle between the plane tangential to teeth of the shell structure 11 and the build platform may be designed according to actual requirements. As used herein, the plane tangential to teeth of the shell structure 11 refers to a plane where the maximum number of points of the outer contour surface 13 are located. For example, when the angle between the plane tangential to teeth of the shell structure 11 and the build platform is relatively small, the entire orthodontic dental appliance 10 and the support 40 may be relatively short so that the printing time for printing one orthodontic dental appliance 10 can be less. Thus, when less printing time is required, the angle between the plane tangential to teeth of the shell structure 11 and the build platform can be set relatively small. As another example, when the angle between the plane tangential to teeth of the shell structure 11 and the build platform is relatively large, the footprint of the orthodontic dental appliance 10 may be relatively small so that more orthodontic dental appliances can be printed in one batch. Thus, when more orthodontic dental appliances need to be printed simultaneously, the angle between the plane tangential to teeth of the shell structure 11 and the build platform can be set relatively large.

Moreover, since the orthodontic dental appliance 10 and the support 20 are printed layer by layer, the greater the angle between the plane tangential to teeth of the shell structure 11 and the build platform is, the more difficult the orthodontic dental appliance 10 and the support 20 may be printed, or the worse the printed orthodontic dental appliance 10 and the support 20 may be. In order to make the printed orthodontic dental appliance 10 more accurate, that is, to make the printed orthodontic dental appliance 10 more conform to the user's tooth shape, the angle between the plane tangential to teeth of the shell structure 11 and the build platform may be in a range of 20° to 90°. In some embodiments, the angle between the plane tangential to teeth of the shell structure 11 and the build platform may be in a range of 20° to 80°. In some embodiments, the angle between the plane tangential to teeth of the shell structure 11 and the build platform may be in a range of 25° to 80°. In some embodiments, the angle between the plane tangential to teeth of the shell structure 11 and the build platform may be in a range of 35° to 75°. In some embodiments, the angle between the plane tangential to teeth of the shell structure 11 and the build platform may be in a range of 50° to 75°. In some embodiments, the angle between the plane tangential to teeth of the shell structure 11 and the build platform may be in a range of 50° to 70°. In some embodiments, the angle between the plane tangential to teeth of the shell structure 11 and the build platform may be 70°. In some embodiments, the angle between the plane tangential to teeth of the shell structure 11 and the build platform may be 55°.

In some embodiments, if a total number of the middle support struts 31 is equal to a total number of the main support struts 41 and each middle support strut 31 is in a straight line with the corresponding main support strut 41, in order to form the angle between the plane tangential to teeth of the shell structure 11 and the build platform, a total height of a middle support strut 31 and the corresponding main support strut 41 under the mesial teeth may be larger than a total height of a middle support strut 31 and the corresponding main support strut 41 under under the distal teeth. For example, the height of all main support struts 41 may be the same or substantially the same, and the height of the middle support struts 31 under the mesial teeth may be larger than the height of the middle support struts 31 under the distal teeth. As another example, in order to use less washing agent and make the post-processing more economical, the height of all middle support struts 31 may be the same or substantially the same, and the height of the main support struts 41 under the mesial teeth may be larger than the main support struts 41 under the distal teeth. In the meantime, the height of the middle support struts 31 may be smaller than any main support strut 41.

In some embodiments, in order to use less washing agent and make the post-processing more economical, the tallest main support strut 41 may be longer than the tallest middle support strut 31. In some embodiments, a ratio of the tallest main support strut 41 to the tallest middle support strut 31 may be in a range of 1.5 to 8. In some embodiments, a ratio of the tallest main support strut 41 to the tallest middle support strut 31 may be in a range of 1.5 to 7. In some embodiments, a ratio of the tallest main support strut 41 to the tallest middle support strut 31 may be in a range of 2 to 6.5. In some embodiments, a ratio of the tallest main support strut 41 to the tallest middle support strut 31 may be in a range of 2.5 to 5.

In some embodiments, since the main support 40 mainly provides stable support for the orthodontic dental appliance 10 during the printing process while the middle support 30 mainly provides support for the orthodontic dental appliance 10 during the post-processing process, a total number of the plurality of middle support struts 31 may be smaller than a total number of the main support struts 41.

In some embodiments, the main support 40 may have a structure different from the structure illustrated in FIG. 1 or FIG. 2. FIG. 4 is a schematic diagram illustrating a 3D printed orthodontic dental appliance with an exemplary support according to some embodiments of the present disclosure.

As shown in FIG. 4, instead of including the main support base mash 43 and the plurality of main support struts 41, a main support 50 may include two side support walls 52 and a connecting support wall 51 connecting the two side support walls 52. Respective ends of the two side support walls 52 may be connected to the rim 34 of the middle support base mesh 33 at least at two ends of the orthodontic dental appliance 10. The side support walls 52 may connect the middle support base mesh 33 and/or the orthodontic dental appliance 10 to the build platform 60.

The side support walls 52 may be configured to support the middle support 30 and/or the shell structure 11 and provide force support points for removing the support 20. Specifically, when removing the support 20, the operator typically needs to apply force from a starting point. In this case, the side support wall 52 serves as the designated starting point for applying force. With its specific surface area, such as the example of using the thumb to apply force, the side support wall 52 offers a stable surface that ensures there is no risk of causing thin shell deformation when force is exerted upon the support 20. The connecting support wall 51 may be configured to ensure the lateral deformation control of the orthodontic dental appliance 10, that is, to avoid the deformation of the orthodontic dental appliance 10 along the horizontal direction. In some embodiments, as shown in FIG. 4, the connecting support wall 51 may connect to the two side support walls 52 directly at side surfaces of the two side support walls 52. That is, the connecting support wall 51 may connect the two side support walls 52 in a straight line. In some embodiments, in order to improve the stability of the main support 50, the connecting support wall 51 may connect to the two side support walls 52 at side surfaces of the two side support walls 52 along a long-axis direction of a projection of the orthodontic dental appliance 10 on the build platform 60.

In some embodiments, a connection part 53 may be disposed between the main support 50 and the build platform 60 and be configured to increase the attachment of the main support 50 to the build platform 60.

In some embodiments, the main support 50 may connect to the middle support base mesh 33 directly. In other words, a connecting part of the main support 50 and the middle support base mesh 33 may be a continued line. In some embodiments, a length of the connecting part of the main support 50 and the middle support base mesh 33 may be in a range of 0.5 mm-2.5 mm. In some embodiments, a length of the connecting part of the main support 50 and the middle support base mesh 33 may be in a range of 1 mm-1.5 mm. In some embodiments, the connecting part of the main support 50 and the middle support base mesh 33 may be perforated to facilitate the separation of the main support 50 from the middle support 30. In other words, the connecting part of the main support 50 and the middle support base mesh 33 may not be a continued line, but a plurality of separated support connecting points. In some embodiments, in order to ensure the reinforcement capability of the main support 50 and use as little printing material as possible, a distance between two adjacent support connecting points may be in a range of 0.2 mm-3 mm. In some embodiments, the distance between two adjacent support connecting points may be in a range of 0.5 mm-2.5 mm. In some embodiments, the distance between two adjacent support connecting points may be in a range of 0.5 mm-2 mm. In some embodiments, the distance between two adjacent support connecting points may be in a range of 0.5 mm-1.5 mm. In some embodiments, the distance between two adjacent support connecting points may be in a range of 0.8 mm-1 mm.

According to some embodiments of the present disclosure, since the design of the main support 50 shown in FIG. 4 uses less printing material (e.g., resin) than the design of the main support 40 shown in FIG. 1 or FIG. 2, it's feasible to wash the main support 50 together with the middle support 30 and the orthodontic dental appliance 10. In other words, the main support 50 doesn't need to be removed before the post-processing, such as washing or cleaning. In some embodiments, the main support 50 may be a solid structure, such as a solid plate-like wall. In some embodiments, in order to support the orthodontic dental appliance 10 more stable and save printing material during printing, the thickness of the main support 50 with a solid plate-like wall may be in a range of 0.5 mm-5 mm. In some embodiments, the thickness of the main support 50 with a solid plate-like wall may be in a range of 0.5 mm-4 mm. In some embodiments, the thickness of the main support 50 with a solid plate-like wall may be in a range of 0.5 mm-3 mm. In some embodiments, the thickness of the main support 50 with a solid plate-like wall may be in a range of 0.5 mm-2 mm. In some embodiments, the thickness of the main support 50 with a solid plate-like wall may be in a range of 0.5 mm-1.5 mm. In some other embodiments, the main support 50 may be a mesh structure, such as a mesh comprising a plurality of inter-connected geometric shapes (e.g., triangle) or a mesh comprising a plurality of inter-connected lattices.

FIG. 5 is a schematic diagram illustrating a 3D printed orthodontic dental appliance with an exemplary support according to some embodiments of the present disclosure.

In some embodiments, as shown in FIG. 5, in order to support the orthodontic dental appliance 10 more stably along the printing direction, the main support 50 may further include a central support 54 that at least connects a part of the middle support 30 to the build platform. For example, in order to ensure even force distribution on the main support 50 and print the orthodontic dental appliance 10 stably, the central support 54 may connect a middle part (e.g., point A shown in FIG. 5) or substantially middle part of the middle support 30 to the build platform. Furthermore, with the presence of the central support 54, when removing the middle support 30, the central support 54 can serve as a crucial support point. This allows the operator to remove the middle support 30 from both ends towards the central support 54, effectively preventing deformation of the shell structure 11. Without the central support 54, the operator would typically move from one end to the other, increasing the likelihood of thin shell deformation. In contrast, utilizing the central support 54, the operator can proceed from one end to the central point and then from the other end to the central point, minimizing the risk of deformation. In some embodiments, the central support 54 may include a solid structure and/or a mesh structure comprising inter-connected 2D geometric shapes or 3D lattices.

In some embodiments, the central support 54 may be column with one end at a middle part A of the middle support 30 and the other end at a projected location B of the middle part A on the build platform along a projection direction parallel to the printing direction of the 3D printing device. In other words, the central support 54 may be perpendicular to the build platform.

In some embodiments, as shown in FIG. 5, in order to improve the stability of the main support 50, the central support 54 may have a triangle shape of three end points at: the middle part A of the middle support 30, the projected location B of the middle part A on the build platform along the printing direction of the 3D printing device, and a middle part C of the connecting support wall 51, respectively.

In some embodiments, in order to further reinforce the support 20 to avoid the deformation of the orthodontic dental appliance during printing, the main support 50 may further include at least one side beam 55 that connects the central support 54 to one of the two side support walls 52. For example, in order to reinforce the support 20 as much as possible, the main support 50 may include two side beams 55, each of which connects the central support 54 to each of the two side support walls 52. In some embodiments, the side beam 55 may include a solid structure or a mesh structure comprising inter-connected 2D geometric shapes or 3D lattices.

According to some embodiments of the present disclosure, the addition of the central support 54 and/or the side beam 55 can provide additional support to the shell structure 11 during printing and/or washing. In addition, the central support 54 and/or the side beam 55 can be removed before washing or be washed together with the middle support 33.

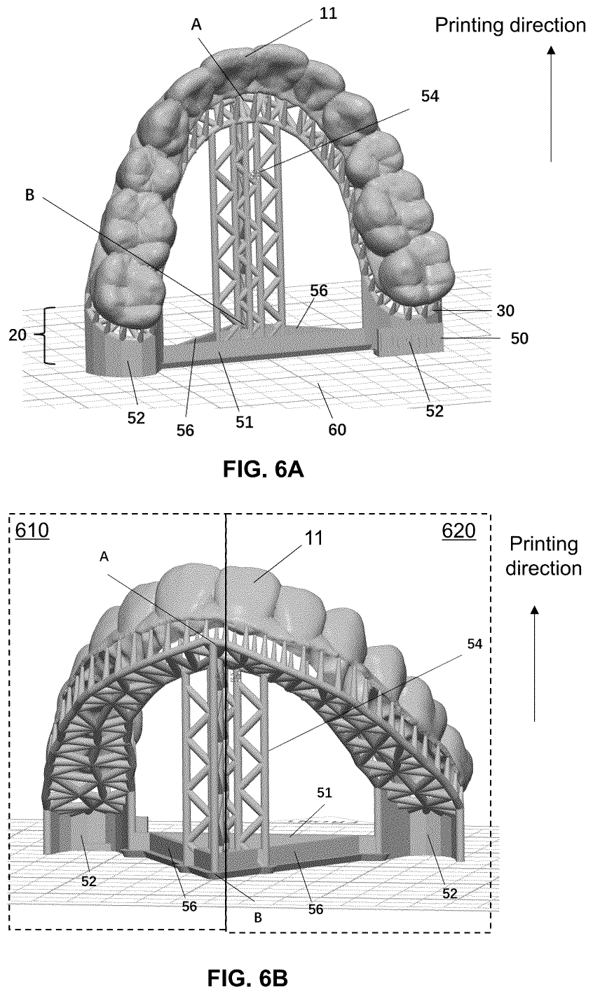

FIG. 6A is a schematic diagram illustrating a 3D printed orthodontic dental appliance with an exemplary support according to some embodiments of the present disclosure. FIG. 6B is another view of the 3D printed orthodontic dental appliance with the exemplary support in FIG. 6A.

In some embodiments, as shown in FIG. 6A or FIG. 6B, when the central support 54 is a column as described above, in order to provide sufficiently support for the orthodontic dental appliance 10 and ensure the lateral deformation control of the orthodontic dental appliance 10, other than the central support 54, the main support 50 may further include two additional connecting walls 56, that connect a portion of the central support 54 corresponding to the projected location B of the middle part A on the build platform and the connecting support wall 51 to form a triangular main support base structure with the connecting support wall 51. Specifically, as shown in FIG. 6B, the shell structure 11, the central support 54, and the connecting walls 56 may form two triangle-like shapes 610 and 620. The two triangle-like shapes 610 and 620 are orthogonal to the triangular main support base structure, thereby forming a more stable support structure.

In some embodiments, the triangular main support base structure may be hollow and include three sides as the connecting support wall 51 and the two connecting walls 56. In some other embodiments, the triangular main support base structure may be solid to provide more attachment between the main support 50 and the build platform 60.

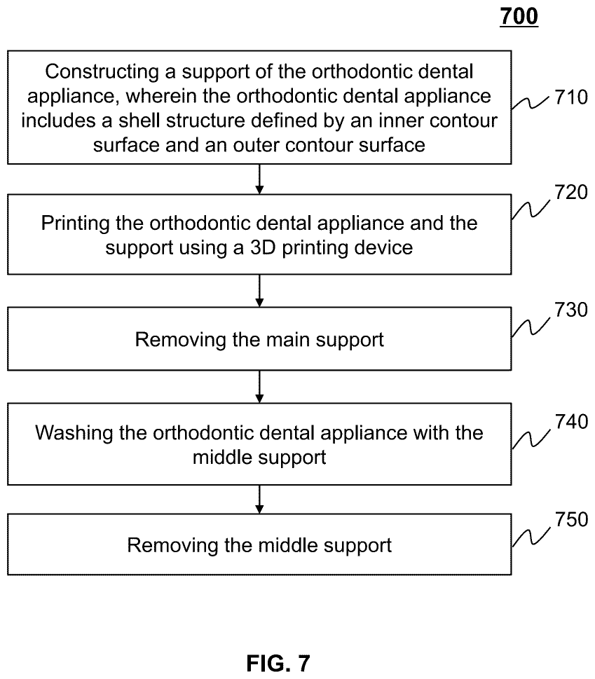

FIG. 7 is a flowchat illustrating an exemplary process for printing a 3D printed orthodontic dental appliance according to some embodiments of the present disclosure. Since different orthodontic dental appliances of different thicknesses and/or hardnesses require different supports, when an orthodontic dental appliance with a relatively small thickness (e.g., less than 1.5 mm, such as 1.2 mm, 1 mm, 0.8 mm, etc.) and/or a relatively soft shell structure needs to be printed, an operator can adopt the support 20 illustrated in FIGS. 1-3, 4-5, 6A, and 6B to print the orthodontic dental appliance. For example, if an aligner whose thickness is generally less than 1.5 mm needs to be printed, the operator may adopt the support 20 to print the aligner. A method for printing a 3D printed orthodontic dental appliance with a relatively small thickness and/or a relatively soft shell structure may include the following operations.

In 710, a support of an orthodontic dental appliance may be constructed. The orthodontic dental appliance includes a shell structure defined by an inner contour surface and an outer contour surface. The support includes a middle support including a middle support base mesh and a plurality of middle support struts, wherein one end of each middle support strut of the plurality of middle support struts is connected to the orthodontic dental appliance at a junction of the inner contour surface and the outer contour surface and the other end of the middle support strut is connected to the rim of the middle support base mesh, and a main support configured to connect the middle support to a build platform of a 3D printing device used to print the orthodontic dental appliance. The support may be the support 20 illustrated in FIGS. 1-3, 4-5, 6A, and 6B.

In 720, the orthodontic dental appliance and the support may be printed using the 3D printing device.

In 730, after the orthodontic dental appliance and the support is printed, the main support may be removed. In other words, the main support may be firstly removed from the middle support and only the orthodontic dental appliance attached with the middle support undergo subsequent steps, such as washing and cleaning step.

In 740, the orthodontic dental appliance with the middle support may be washed.

In 750, the middle support may be removed. After the washing and cleaning, the middle support is then removed from the aligner for potentially other post-processing steps, such as post-curing. In some embodiments, the orthodontic dental appliance may undergo other applicable post-processing steps, such as burnishing.

The possible beneficial effects of using two parts of support (including the main support and a middle support) are to have stable enough support structures to make sure the orthodontic dental appliance can be printed without deformation. In the meantime, after the orthodontic dental appliance is printed, the main support (e.g., the main support 40, the main support 50) can be firstly removed and then only the shell structure 11 and the middle support 30 are washed and cleaned. Afterwards, the middle support 30 can then be removed to obtain the orthodontic dental appliance. If the support only has one part, the support has to be substantial enough to prevent printing and washing deformation, which is then for sure taking more washing agent to clean with and more resin material to build. Because of the structure of the middle support base mesh, it provides support of the opening of the shell structure from deformation not only during printing but also during washing and post-curing.

In the embodiments where the area of the middle support contacting points are larger than the area of the main support contacting points, this difference can facilitate the separation of the main support from the middle support. An operator can easily remove the main support first without separating the middle support from the shell structure. In the embodiments disclosed in the present invention, the main support may have the thicker struts than the middle support that provide sufficient support along the printing direction. During post-processing, the main support with thicker struts can be removed first before washing and cleaning, so less cleaning agent can be used.

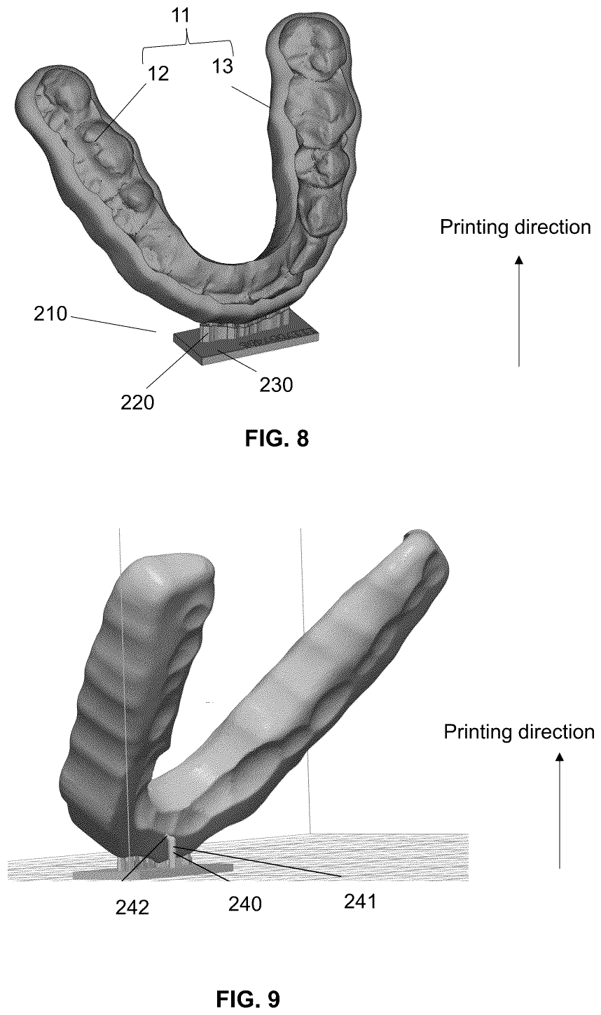

FIG. 8 is a schematic diagram illustrating a 3D printed orthodontic dental appliance with an exemplary support according to some embodiments of the present disclosure. In some embodiments, when an orthodontic dental appliance with a thickness greater than 1.2 mm (e.g., 1.5 mm, 2 mm, etc.) or having a relatively hard shell structure needs to be printed, a 3D printing support 210 shown in FIG. 8 can be provided. For example, if a night guard whose thickness is generally greater than 1.5 mm needs to be printed, the operator may adopt the support 210 shown in FIGS. 8-10 to print the night guard.

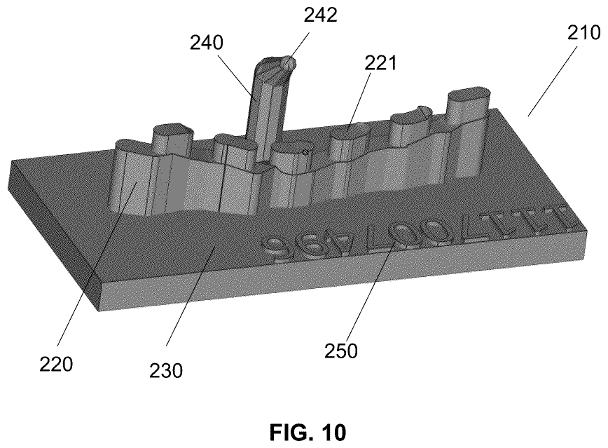

In some embodiments, as shown in FIG. 8, the 3D printing support 210 of a 3D printed orthodontic dental appliance (or a shell structure 11) may include a support wall 220 and a support base 230. The support wall 220 may connect the support base 230 and the shell structure 11. During the 3D printing process, the support base 230 is located on a build platform of a 3D printing device used to print the orthodontic dental appliance. The build platform is perpendicular to a printing direction of the 3D printing device. In some embodiments, the support base 230 may be used to print a mark (e.g., a mark 250 shown in FIG. 10) that can identify the printed orthodontic dental appliance, such as a patent ID, a batch ID, etc.

In some embodiments, along the printing direction, one end of the support wall 220 may be connected to the support base 230 and the other end of the support wall 220 may be connected the outer contour surface 13 of the orthodontic dental appliance (or the shell structure 11). Specifically, the other end of the support wall 220 may be connected to a portion of the outer contour surface 13 corresponding to a biting edge of at least one anterior tooth of a user of the orthodontic dental appliance (or the shell structure 11). Such design is to ensure that after removal of the support 210, even without any post-polishing process, any possible remaining portion of the support 210 is located at a location that does not interfere with the normal use of the orthodontic dental appliance. In other words, when any possible remaining portion of the support 210 is located on the biting edge of user's anterior tooth, the remaining portion of the support 210 does not touch the inside of the user's lip or tongue. As a result, the support 210 can be removed from the orthodontic dental appliance with a one-click motion (also referred to as single snap motion), thereby simplifying the manufacturing process of the orthodontic dental appliance.

In some embodiments, the support wall 220 may be perpendicular to the support base 230. In some embodiments, the support wall 220 may be connect to the support base 230 at an acute angle, such as 45°, 50°, 60°, 80°, etc., so that the entire shell structure 11 and the support 210 can be stably placed on the build platform. Further, by adjusting the angle between the support wall 220 and the support base 230, an angle between a plane tangential to teeth of the shell structure 11 and the support base 230 (or the build platform) may be adjusted to meet actual needs. For example, if the support wall 220 forms an angle with the support base 230 along a certain direction, the plane tangential to teeth of the shell structure 11 may titl along a direction opposite to the certain direction to make the plane tangential form an desired angle with the support base 230. More description about the angle between the plane tangential to teeth of the shell structure 11 and the support base 230 may be found below. The smaller the acute angle is, the smaller the angle between the plane tangential to teeth of the shell structure 11 and the support base 230 can be set.

In some embodiments, in order to form an angle between the plane tangential to teeth of the shell structure 11 and the support base 230 (or the build platform), the height of a portion near the middle of the support wall 220 may be lower than the height of a portion at both ends of the support wall 220 along a direction perpendicular to the printing direction. Since the lower the support wall 220 is, the better the stability of the shell structure 11 may be, in some embodiments, in order to ensure sufficient force is provided to support the shell structure 11 and facilitate the separation of the support 210 from the shell structure 11, the height of the edge portion of the support wall 220 may be in a range of 2 mm-5 mm, and the height of the middle portion of the support wall 220 may be in a range of 1.5 mm-3.5 mm. In some embodiments, the height of the edge portion of the support wall 220 may be in a range of 2.5 mm-4.5 mm, and the height of the middle portion of the support wall 220 may be in a range of 1.8 mm-3 mm. In some embodiments, the height of the edge portion of the support wall 220 may be in a range of 3 mm-4 mm, and the height of the middle portion of the support wall 220 may be in a range of 2 mm-2.5 mm. In some embodiments, the height of the edge portion of the support wall 220 may be 3.6 mm, and the height of the middle portion of the support wall 220 may be in a range of 2.1 mm.

In some embodiments, in order to ensure that the support 210 provides stable support for the shell structure 11, a thickness of the support base 230 may be in a range of 0.5 mm-4 mm. In some embodiments, the thickness of the support base 230 may be in a range of 0.5 mm-4 mm. In some embodiments, the thickness of the support base 230 may be in a range of 1.0 mm-3 mm. In some embodiments, the thickness of the support base 230 may be in a range of 1 mm-2 mm. In some embodiments, the thickness of the support base 230 may be 1.4 mm.

In some embodiments, as shown in FIG. 8, the support wall 220 may connect to the shell structure 11 directly. In other words, a connecting part of the support wall 220 and the shell structure 11 may be a continued line (e.g., a straight line or a curved line). In some embodiments, a length of the connecting part (i.e., the continued line) of the support wall 220 and the shell structure 11 may be in a range of 1.2 cm-3 cm. In some embodiments, the length of the connecting part of the support wall 220 and the shell structure 11 may be in a range of 1.5 cm-2.8 cm. In some embodiments, the length of the connecting part of the support wall 220 and the shell structure 11 may be in a range of 1.7 cm-2.5 cm. In some embodiments, the length of the connecting part of the support wall 220 and the shell structure 11 may be 2 cm. In some embodiments, a straight distance between the two ends of the support wall 220 in the direction perpendicular to the printing direction may be in a range of 1 cm-2.5 cm. In some embodiments, the straight distance between the two ends of the support wall 220 in the direction perpendicular to the printing direction may be in a range of 1.2 cm-2.3 cm. In some embodiments, the straight distance between the two ends of the support wall 220 in the direction perpendicular to the printing direction may be in a range of 1.4 cm-2.1 cm. In some embodiments, the straight distance between the two ends of the support wall 220 in the direction perpendicular to the printing direction may be in a range of 1.5 cm-2 cm.

FIG. 9 is a schematic diagram illustrating a 3D printed orthodontic dental appliance with an exemplary support according to some embodiments of the present disclosure. FIG. 10 is a schematic diagram illustrating a support to support a 3D printed orthodontic dental appliance according to some embodiments of the present disclosure.

In other embodiments, as shown in FIG. 9 and FIG. 10, the connecting part of The support wall 220 and the shell structure 11 may be perforated. In other words, the connecting part of the support wall 220 and the shell structure 11 may not be a continued line, but a plurality of separated support connection points 221. The purpose of the perforated design is to make the removal of the support 210 from the shell structure 11 easier. In some embodiments, in order to ensure the reinforcement capability of the support 210 and use as little printing material as possible, a distance between two adjacent support connection points may be in a range of 0.2 mm-3 mm. In some embodiments, the distance between two adjacent support connection points may be in a range of 0.5 mm-2.5 mm. In some embodiments, the distance between two adjacent support connection points may be in a range of 0.5 mm-2 mm. In some embodiments, the distance between two adjacent support connection points may be in a range of 0.5 mm-1.5 mm. In some embodiments, the distance between two adjacent support connection points may be in a range of 0.8 mm-1 mm.

In some embodiments, in order to further reinforce the support 210 to stabilize the orthodontic dental appliance during printing to improve the printing accuracy, the support 210 may contain at least one support column 240 with one end connected to the support base 230 and the other end connected to the outer contour surface 13 of the shell structure 11. By providing the support column 240, the operator can easily remove (e.g., through the one-click motion) the entire support 210 (including the support wall 220, the support base 230, and the support column 240) from the shell structure 11 along a first direction from the support column 240 to the support wall 220. This is because a first angle between the operator's finger abutting the support 210 (i.e., the support column 240) and the support wall 220 when the operator removes the support 210 along the first direction may be greater than a second angle between the operator's finger abutting the support 210 (i.e., the support wall 220) and the support wall 220 when the operator removes the support 210 along a second direction from the support wall 220 to the support column 240, thus the force exerted on the support 210 when the operator removes the support 210 along the first direction may be correspondingly greater to more easily remove the support 210 from the shell structure 11.

In some embodiments, the support column 240 may be connected to any position on the outer contour surface 13 of the shell structure 11. For example, the support column 240 may connect to a point at an end of the orthodontic dental appliance. As another example, the support column 240 may connect the support base 230 and a middle point of the biting edge of the at least one anterior tooth of the user to stabilize the orthodontic dental appliance as much as possible.

In some embodiments, in order to reinforce the support for the shell structure 11 as much as possible, the support column 240 may contain a main body 241 that is perpendicular to the support base 230. In some embodiments, the main body 241 may be parallel to the support wall 220.

In some embodiments, in order to facilitate the separation of the support column 240 (or the support 210) from the shell structure 11, the support column 240 may further contain a contacting head 242 to facilitate the removal of the support 210. In some embodiments, the contacting head 242 may be a sphere, column, ellipses, etc., or any other irregular shape. In some embodiments, when the contacting head 242 is a column, the contacting head 242 may be at an angle to the main body 241 to facilitate the removal of the support 210. Since the closer an angle between the cylindrical contacting head 242 and the the outer contour surface 13 of the contact position is to 90°, the more conductive it is to the removal of the support 210, in some embodiments, the columnar contacting head 242 may be perpendicular to the outer contour surface 13 of the contact position to facilitate the removal of the support 210. In some embodiments, a cross-sectional area of the columnar contacting head 242 along a direction parallel to a main body of the column may be smaller than a cross sectional area of the main body 241 along a direction parallel to the main body 241 to facilitate the separation of the support column 240 (or the support 210) from the shell structure 11. In some embodiments, a diameter of the columnar contacting head is smaller than a diameter of the main body 241. In some embodiments, the diameter of the main body 241 may be in a range of 0.5 mm-5 mm. In some embodiments, the diameter of the main body 241 may be in a range of 0.5 mm-4 mm. In some embodiments, the diameter of the main body 241 may be in a range of 1 mm-3 mm. In some embodiments, the diameter of the main body 241 may be in a range of 1 mm-2 mm. In some embodiments, the diameter of the columnar contacting head 242 may be in a range of 0.5 mm-3 mm. In some embodiments, the diameter of the columnar contacting head 242 may be in a range of 0.5 mm-2 mm. In some embodiments, the diameter of the columnar contacting head 242 may be in a range of 0.5 mm-1.5 mm. In some embodiments, the diameter of the columnar contacting head 242 may be in a range of 0.8 mm-1.2 mm.

In some embodiments, the contacting head 242 may be a sphere, at this time, the contacting head 242 may be disposed at the edge of the upper end of the main body 241 to facilitate the separation of the support column 240 (or the support 210) from the shell structure 11. In this way, the outer contour surface 13 of the shell structure 11 can be tangent to the sphere at the contacting point between the shell structure 11 and the contacting head 242.

In some embodiments, the contacting head 242 of the support column 240 may be located at the middle point of the biting edge of anterior teeth of the user to balance the shell structure 11 during printing.

In some embodiments, since an angle between a plane tangential to teeth of the shell structure 11 and the support base 230 (or the build platform) may be related to the spatial layout of the orthodontic dental appliance and the support 210, which can affect e.g., a printing time, the throughput, etc., of the orthodontic dental appliance and the support 210, the angle between the plane tangential to teeth of the shell structure 11 and the support base 230 (or the build platform) may be designed according to actual requirements. For example, when an angle between a plane tangential to teeth of the shell structure 11 and the support base 230 (or the build platform) is relatively small, the entire orthodontic dental appliance and the support 210 may be relatively short so that the printing time for the orthodontic dental appliance can be less. Thus, when less printing time is required, the angle between the plane tangential to teeth of the shell structure 11 and the support base 230 (or the build platform) can be set relatively small. As another example, when the angle between the plane tangential to teeth of the shell structure 11 and the support base 230 (or the build platform) is relatively large, the footprint of the orthodontic dental appliance may be relatively small so that more orthodontic dental appliances can be printed in one batch. Thus, when more orthodontic dental appliances need to be printed simultaneously, the angle between the plane tangential to teeth of the shell structure 11 and the support base 230 (or the build platform) can be set relatively large.

Moreover, since the shell structure 11 and the support 210 are printed layer by layer, the greater the angle between the plane tangential to teeth of the shell structure 11 and the support base 230 (or the build platform) is, the more difficult the shell structure 11 and the support 210 may be printed, or the worse the printed shell structure 11 and the support 210 may be. In some embodiments, in order to make the printed shell structure 11 more accurate, that is, to make the printed shell structure 11 more conform to the user's tooth shape, the angle between the plane tangential to teeth of the shell structure 11 and the support base 230 (or the build platform) may be in a range of 20° to 90°. In some embodiments, the angle between the plane tangential to teeth of the shell structure 11 and the support base 230 (or the build platform) may be in a range of 30° to 80°. In some embodiments, the angle between the plane tangential to teeth of the shell structure 11 and the support base 230 (or the build platform) may be in a range of 40° to 75°. In some embodiments, the angle between the plane tangential to teeth of the shell structure 11 and the support base 230 (or the build platform) may be in a range of 50° to 60°. In preferred embodiments, the angle between the plane tangential to teeth of the shell structure 11 and the support base 230 (or the build platform) may be in a range of 50° to 55°.

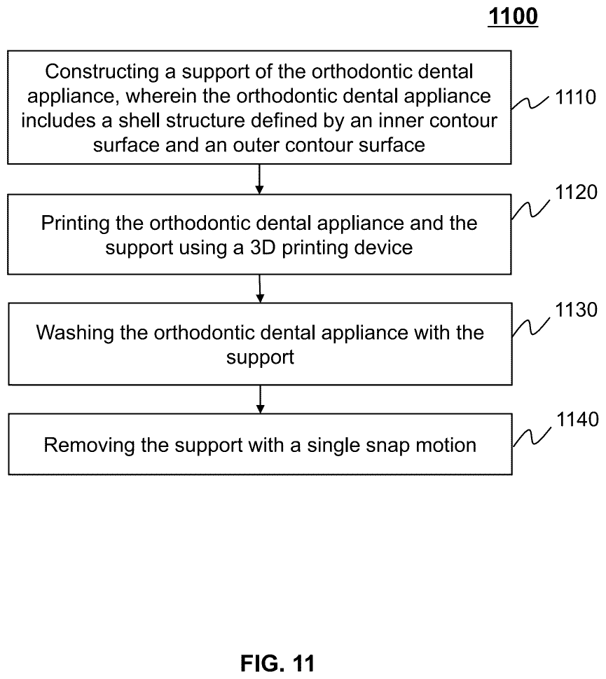

FIG. 11 is a flowchat illustrating an exemplary process for printing a 3D printed orthodontic dental appliance according to some embodiments of the present disclosure. A method for printing a 3D printed orthodontic dental appliance with a relatively large thickness and/or a relatively hard shell structure may include the following operations.

In 1110, a support of the orthodontic dental appliance may be constructed. The orthodontic dental appliance may include a shell structure defined by an inner contour surface and an outer contour surface. The support may incline a support base on a build platform of a 3D printing device used to print the orthodontic dental appliance, the build platform is perpendicular to a printing direction of the 3D printing device, and a support wall with one end connected to the support base and the other end connected to a portion of the outer contour surface corresponding to a biting edge of at least one anterior tooth of a user of the orthodontic dental appliance. The support may be the support 210 illustrated in FIGS. 8-10.

In 1120, the orthodontic dental appliance and the support may be printed using the 3D printing device.

In 1130, after the orthodontic dental appliance and the support is printed, the orthodontic dental appliance with the support may be washed. In some embodiments, the orthodontic dental appliance with the support may undergo other applicable post-processing steps, such as post-curing.

In 1140, the support may be removed with an one-click motion. In some embodiments, the support further includes at least one support column with one end connected to the outer contour surface of the shell structure and the other end connected to the support base. The support may be removed with an one-click motion along a direction from the at least one support column to the support wall. In some embodiments, the orthodontic dental appliance may undergo other applicable post-processing steps, such as burnishing.

The possible beneficial effects of using the support having a support base and a support wall is that not only the support can provide sufficient supporting function during printing and any post-processing steps (such as washing and post-curing), the support can also be removed from the shell structure with an one-click motion. Moreover, since the particular position design (e.g., by designing the support wall 220 of the support 210 to connect to a portion of the outer contour surface 13 corresponding to a biting edge of at least one anterior tooth of a user of the shell structure 11) of the support on the outer contour surface of the shell structure, there is no need to undergo any post-polishing.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure and are within the spirit and scope of the exemplary embodiments of this disclosure.

In some embodiments, the numbers expressing quantities, properties, and so forth, used to describe and claim certain embodiments of the application are to be understood as being modified in some instances by the term “about,” “approximate,” or “substantially.” For example, “about,” “approximate” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

1. A support of a 3D printed orthodontic dental appliance, wherein the orthodontic dental appliance includes a shell structure defined by an inner contour surface and an outer contour surface, comprising:
a middle support including a middle support base mesh and a plurality of middle support struts, wherein one end of each middle support strut of the plurality of middle support struts is connected to the orthodontic dental appliance at a junction of the inner contour surface and the outer contour surface, and the other end of the middle support strut is connected to a rim of the middle support base mesh; and
a main support configured to connect the middle support to a build platform of a 3D printing device used to print the orthodontic dental appliance.

2. The support of claim 1, wherein an angle between a plane tangential to teeth of the shell structure and the build platform is in a range of 20° to 90°.

3. (canceled)

4. The support of claim 1, wherein the middle support base mesh includes a plurality of inter-connected triangles.

5. The support of claim 1, wherein the main support includes two side support walls and a connecting support wall connecting the two side support walls, wherein respective ends of the two side support walls are connected to the rim of the middle support base mesh at least at two ends of the orthodontic dental appliance.

6. The support of claim 5, wherein the connecting support wall connects to the two side support walls directly at side surfaces of the two side support walls.

7. The support of claim 5, further comprising:
a connection part disposed between the main support and the build platform and be configured to increase an attachment of the main support to the build platform.

8. The support of claim 5, wherein the main support further includes:
a central support that at least connects a middle part of the middle support to the build platform.

9. The support of claim 8, wherein the central support has a triangle shape of three end points at the middle part of the middle support, a projected location of the middle part of the middle support on the build platform along a projection direction parallel to a printing direction of the 3D printing device, and a middle part of the connecting support wall, respectively.

10. The support of claim 8, wherein the main support further includes:
at least one side beam that connects the central support to one of the two side support walls.

11. The support of claim 8, wherein the central support is a column with one end at the middle part of the middle support and the other end at a projected location of the middle part of the middle support on the build platform along a projection direction parallel to a printing direction of the 3D printing device.

12. The support of claim 11, wherein the main support further includes:
two additional connecting walls that connect the projected location of the middle part of the middle support on the build platform and the connecting support wall to form a triangular main support base structure.

13. The support of claim 1, wherein the main support includes a main support base mesh and a plurality of main support struts, wherein
one end of the plurality of main support struts is connected to the rim of the middle support base mesh and the other end of the plurality of main support struts is connected to a rim of the main support base mesh.

14. The support of claim 13, wherein the main support base mesh includes a plurality of inter-connected triangles.

15. The support of claim 14, wherein a diameter of each triangle side of inter-connected triangles of the middle support base mesh is smaller than a diameter of each triangle side of the inter-connected triangles of the main support base mesh.

16. The support of claim 13, wherein a cross-sectional area of each middle support strut along a direction perpendicular to a printing direction of the 3D printing device is smaller than a cross-sectional area of each main support strut along the direction perpendicular to the printing direction of the 3D printing device.

17. The support of claim 13, wherein an area of a middle support contacting point of each middle support strut to the orthodontic dental appliance is larger than an area of a main support contacting point of each main support strut to the middle support base mesh.

18. The support of claim 13, wherein
an area of a middle support contacting point of each middle support strut to the orthodontic dental appliance is less than a cross-sectional area of the corresponding middle support strut along a direction perpendicular to a printing direction of the 3D printing device, or
an area of a main support contacting point of each main support strut to the middle support base mesh is less than a cross-sectional area of the corresponding main support strut along the direction perpendicular to the printing direction of the 3D printing device.

19. The support of claim 13, wherein at least two adjacent main support struts are combined into one but keeping corresponding main support contacting points connected to the rim of the middle support base mesh.

20. The support of claim 13, wherein a total number of the plurality of middle support struts is smaller than a total number of the main support struts.

21. (canceled)

22. A support of a 3D printed orthodontic dental appliance, wherein the orthodontic dental appliance includes a shell structure defined by an inner contour surface and an outer contour surface, comprising:
a support base on a build platform of a 3D printing device used to print the orthodontic dental appliance, the build platform is perpendicular to a printing direction of the 3D printing device; and
a support wall with one end connected to the support base along the printing direction and the other end connected to a portion of the outer contour surface corresponding to a biting edge of at least one anterior tooth of a user of the orthodontic dental appliance, wherein
a length of a connecting part of the support wall and the shell structure is smaller than a length of a dental arch of the user.

23-39. (canceled)
